(19) United States
(12) Patent Application Publication
(10) Pub. No.: US 2004/0207715 A1
(43) Pub. Date: Oct. 21, 2004

(54) Bi-directional laser printing using a single axis scanning mirror

(76) Inventors: John W. Orcutt, Richardson, TX (US); Arthur Monroe Turner, Allen, TX (US)

Correspondence Address: TEXAS INSTRUMENTS INCORPORATED, P O BOX 655474, M/S 3999, DALLAS, TX, 75265

(21) Appl. No.: 10/617,591

(22) Filed: Jul. 11, 2003

Related U.S. Application Data
(60) Provisional application No. 60/453,488, filed on Mar. 11, 2003.

(51) Int. Cl. B41J 2/47

(52) U.S. Cl. 347/225

(57) ABSTRACT

A system and method for using a single axis resonant scanning mirror for high quality bi-directional printing. The system moves the photosensitive medium or paper at a constant rate having a selected speed such that image lines of an image overlap.

This application claims the benefit of U.S. Provisional Application No. 60/453,488, filed on Mar. 11, 2003, entitled Laser Printing at Full Cycle with an Oscillating Source, which application is hereby incorporated herein by reference.

### TECHNICAL FIELD

The present invention relates generally to “laser printers” and more specifically to the use of MEMS (micro-electric mechanical systems) type mirrors (such as torsional hinge mirrors) to provide bi-directional resonant scanning across a moving photosensitive medium, such as a rotating drum. The torsional hinges are used for providing the resonant bi-directional scan at a controlled resonant frequency about an axis of oscillation at a rate of 600 dots per inch or greater.

### BACKGROUND

Rotating polygon scanning mirrors are typically used in laser printers to provide a “raster” like scan of the image of a laser light source across a moving photosensitive medium, such as a rotating drum. Such a system requires that the rotation of the photosensitive drum and the rotating polygon mirror be synchronized so that the beam of light (laser beam) sweeps or scans across the rotating drum in one direction as a facet of the polygon mirror rotates past the laser beam. The next facet of the rotating polygon mirror generates a similar scan or sweep which also traverses the rotating photosensitive drum but provides an image line that is spaced or displaced from the previous image line.

There have also been prior art efforts to use a less expensive flat mirror with a single reflective surface, such as a resonant mirror, to provide a scanning beam. For example, a single axis scanning mirror may be used to generate the beam sweep or scan instead of a rotating polygon mirror. The rotating photosensitive drum and the scanning mirror are synchronized as the “resonant” mirror first pivots or rotates in one direction to produce a printed image line on the medium that is at right angles or orthogonal with the movement of the photosensitive medium.

However, the return sweep will traverse a trajectory on the moving photosensitive drum that is at an angle with the printed image line resulting from the previous sweep. Consequently, use of a single reflecting surface resonant mirror according to the prior art required that the modulation of the reflected light beam be interrupted as the mirror completed the return sweep or cycle, and then again start scanning in the original direction. Using only one of the sweep directions of the mirror, of course, reduces the print speed. Therefore, to effectively use an inexpensive resonant mirror according to the prior art required that the mirror surface be continuously and easily adjusted in a direction perpendicular to the scan such that the resonant sweep of the mirror in each direction generated images on a moving or rotating photosensitive drum that were always parallel. This continuous perpendicular movement was typically accomplished by the use of a dual axis torsional mirror, or a pair of single axis mirrors. Of course, either of these solutions is more complex and consequently more expensive than using one single frequency scanning mirror.

Texas Instruments presently manufactures torsional single axis analog mirror MEMS devices fabricated out of a single piece of material (such as silicon, for example) typically having a thickness of about 100-115 microns. The mirror may be of any desired shape, although an elliptical shape is typically preferred. An elongated ellipse shaped mirror is matched to the shape and the angle of the beam is received. As an example, the mirror may have a long axis of about 4.0 millimeters and a short axis of about 1.5 millimeters. The mirror surface is fabricated by hinging the mirror directly to a support structure.

Therefore, it will be appreciated that if a single resonant frequency scanning mirror could be used to provide bi-directional high quality printing, manufacturing costs and inventory costs could be significantly reduced.

### SUMMARY OF THE INVENTION

The problems mentioned above are addressed by the present invention which, according to one embodiment, provides a method of using a single frequency scanning mirror apparatus as the drive engine for generating a sweeping or scanning beam of light across a photosensitive medium, such as for example a rotating drum, to provide high quality bi-directional laser printing.

More specifically, the method of this invention comprises the steps of providing a moving photosensitive medium that is sensitive to a selected light beam. The light beam is intercepted at the reflective surface of a single-frequency scanning mirror and redirected toward the photosensitive medium that is moving at a selected constant speed. The scanning mirror oscillates at the single frequency to sweep the redirected light beam back and forth across the moving photosensitive medium, and digital signals are generated for modulating the light beam in both directions as it sweeps back and forth so as to produce a multiplicity of bi-directional image lines that are combined to create a selective image. The vertical pixel size or image line spacing is selected so that as a worst case, each of the multiplicity of image lines merge or partially overlap the previous image line or the following image line at the left and right limits. To accomplish this, the density of addressable pixels is selected to be about 600 addressable horizontal pixels per inch across the photosensitive medium, and the number of bi-directional image lines are generated at a rate of about 600 pixels or lines per inch.

The resonant frequency mirror apparatus comprises a single reflective surface portion positioned to intercept the beam of light or laser beam from a light source. The reflective surface of the mirror device is supported by a single hinge arrangement, such as torsional hinges, for pivotally oscillating around an axis. These pivotal oscillations of the mirror device about an axis result in a beam of light reflected from the mirror surface moving or sweeping across the photosensitive medium. The mirror apparatus also includes driver circuitry for causing the pivoting oscillations or sweeping motion or scanning across the moving photosensitive medium. The moving photosensitive medium, such as a rotating drum, is located to receive the reflected bi-directional modulated light beam as it sweeps a trace across the drum or moving medium between left and right edges. The photosensitive medium rotates or moves in a direction such that sequential image lines or traces are generated at a rate of at least 600 pixels or lines per inch.

### BRIEF DESCRIPTION OF THE DRAWINGS

Other objects and advantages of the invention will become apparent upon reading the following detailed description and upon referencing the accompanying drawings in which:

FIGS. 1A, 1B, and 1C illustrate the use of a rotating polygon mirror for generating the sweep of a laser printer according to the prior art;

FIGS. 2A, 2B, 2C, and 2D illustrate a prior art example of using a single axis flat resonant mirror to generate a unidirectional beam sweep of a laser printer;

FIGS. 3A and 3B are embodiments of single axis non-resonant and resonant scanning torsional hinge mirrors;

FIGS. 4A-4B are cross-sectional views of FIG. 3A illustrating rotation or pivoting about the torsional hinges;

FIG. 5 is a perspective illustration of the use of one single axis mirror such as shown in FIGS. 3A and 3B to generate the single directional beam sweep of a laser printer according to the teachings of another embodiment of the present invention;

FIG. 6 illustrates the laser spot size and relative pixel size on a photosensitive medium;

FIG. 7 illustrates pixel resolution and laser spot size according to the present invention;

FIG. 8 illustrates the decreasing visibility of zig-zag print lines as print rates or dots per inch increases;

FIGS. 9A and 9B illustrate how laser spots overlap at the center of a beam scan and the end of a beam scan respectively; and

FIG. 10 illustrates minimal overlap to avoid artifacts due to zig-zag image lines.

### DETAILED DESCRIPTION OF ILLUSTRATIVE EMBODIMENTS

Like reference numbers in the figures are used herein to designate like elements throughout the various views of the present invention. The figures are not intended to be drawn to scale and in some instances, for illustrative purposes, the drawings may intentionally not be to scale. One of ordinary skill in the art will appreciate the many possible applications and variations of the present invention based on the following examples of possible embodiments of the present invention. The present invention relates to laser printers and primarily to the use of a basic single frequency scanning mirror apparatus with a moveable reflecting surface that is suitable for use to provide the raster scans for both a multi-speed laser beam type printer, or for various models of single speed printers where the various models operate at substantially different print speeds.

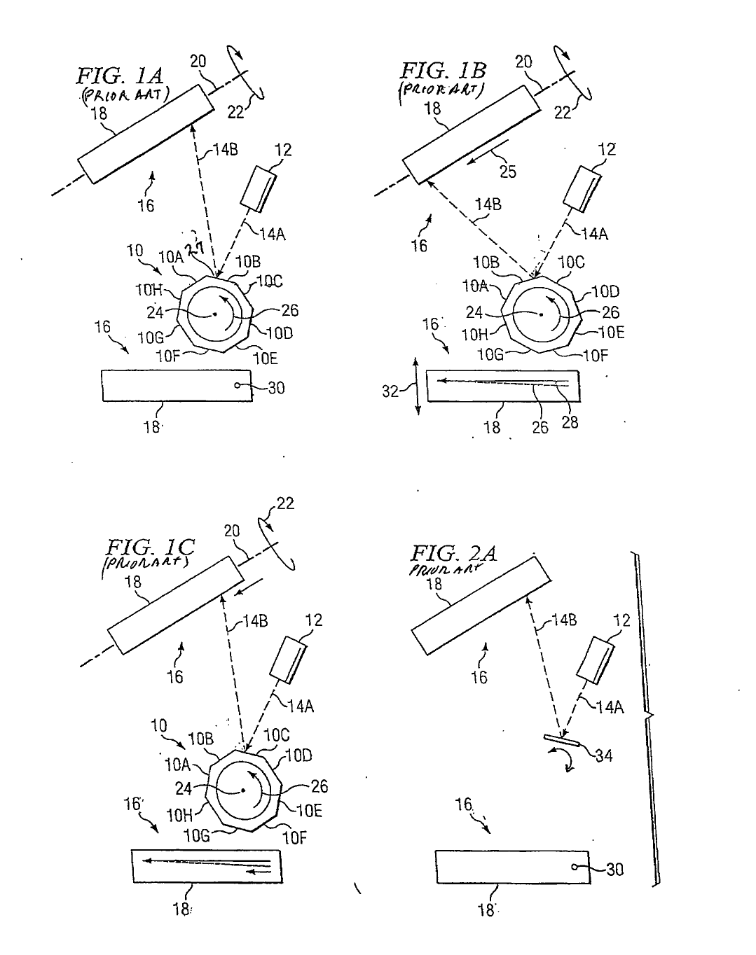

Referring now to FIGS. 1A, 1B and 1C, there is shown an illustration of the operation of a prior art printer using a rotating polygon mirror. As shown in FIG. 1A, there is a rotating polygon mirror 10 which in the illustration has eight reflective surfaces 10A-10H. A light source 12 produces a beam of light, such as a laser beam, that is focused on the rotating polygon mirror so that the beam of light from the light source 12 is intercepted by the facets 10A-10H of rotating polygon mirror 10. Thus the laser beam of light 14A from the light source 12 is reflected from the facets 10A-10H of the polygon mirror 10 as illustrated by dashed line 14B to a moving photosensitive medium 16 such as a rotating photosensitive drum 18 having an axis of rotation 20. The moving photosensitive medium 16 or drum 18 rotates around axis 20 in a direction as indicated by the arcurate arrow 22 such that the area of the moving photosensitive medium 16 or drum 18 exposed to the light beam 14B is continuously changing. As shown in FIG. 1A, the polygon mirror 10 is also rotating about an axis 24 (axis is perpendicular to the drawing in this view) as indicated by the second arcurate arrow 26. Thus, it can be seen that the leading edge 27 of facet 10B of rotating polygon mirror 10 will be the first part of facet 10B to intercept the laser beam of light 14A from the light source 12. As the mirror 10 rotates, each of the eight facets of mirror 10 will intercept the light beam 14A in turn. As will be appreciated by those skilled in the art, the optics to focus the light beam, the lens system to flatten the focal plane to the photosensitive drum, and any fold mirrors to change the direction of the scanned beam are omitted for ease of understanding.

Illustrated below the rotating polygon mirror 10 is a second view of the photosensitive medium 16 or drum 18 as seen from the polygon scanner. As shown by reference number 30 on the photosensitive drum view 18, there is the beginning point of an image of the laser beam 14B on drum 18 immediately after the facet 10B intercepts the light beam 14A and reflects it to the moving photosensitive medium 16 or drum 18.

Referring now to FIG. 1B, there is shown substantially the same arrangement as illustrated in FIG. 1A except the rotating polygon mirror 10 has continued its rotation about axis 24 such that the facet 10B has rotated so that its interception of the laser beam 14A is about to end. As will also be appreciated by those skilled in the art, because of the varying angle the mirror facets present to the intercepted light beam 14A, the reflected light beam 14B will move across the surface of the rotating drum as shown by arrow 25 and dashed line 26 in FIG. 1B.

However, it will also be appreciated that since rotating drum 18 was moving orthogonally with respect to the scanning movement of the light beam 14B, that if the axis of rotation 24 of the rotating mirror was exactly orthogonal to the axis 20 of the rotating photosensitive drum 18, an image of the sweeping or scanning light beam on the photosensitive drum would be recorded at a slight angle. As shown more clearly by the lower view of the photosensitive drum 18, dashed line 26 illustrates that the trajectory of the light beam 14B is itself at a slight angle, whereas the solid line 28 representing the resulting image on the photosensitive drum is not angled but orthogonal to the rotation or movement of the photosensitive medium 16. To accomplish this parallel printed line image 28, the rotating axis 24 of the polygon mirror 10 is typically mounted at a slight tilt with respect to the rotating photosensitive drum 18 so that the amount of vertical travel or distance traveled by the light beam along vertical axis 32 during a sweep or scan across medium 16 is equal to the amount of movement or rotation of the photosensitive medium 16 or drum 18. Alternately, if necessary, this tilt can also be accomplished using a fold mirror that is tilted.

FIG. 1C illustrates that facet 10B of rotating polygon mirror 10 has rotated away from the light beam 14A, and facet 10C has just intercepted the light beam. Thus, the process is repeated for a second image line. Continuous rotation will of course result in each facet of rotating mirror 10 intercepting light beam 14A so as to produce a series of parallel and spaced image lines which when viewed together will form a line of print or other image.

It will be further appreciated by those skilled in the laser printing art, that the rotating polygon mirror is a very precise and expensive part or component of the laser printer that must spin at terrific speeds without undue wear of the bearings even for rather slow speed printers. Therefore, it would be desirable if a less complex flat mirror, such as for example a resonant flat mirror, could be used to replace the complex and heavy polygonal scanning mirror.

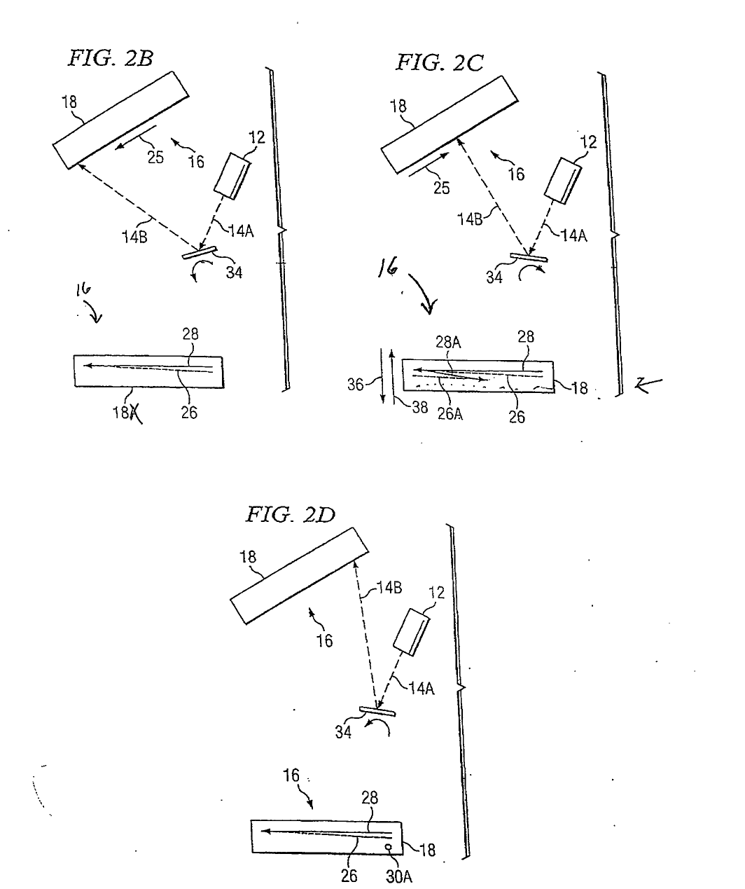

Referring now to FIGS. 2A, 2B, 2C and 2D, there is illustrated a prior art example of a laser printer using a single-axis oscillating mirror to generate the beam sweep. As will be appreciated by those skilled in the art and as illustrated in the following figures, prior art efforts have typically been limited to only using one direction of the oscillating beam sweep because of the non-parallel image lines generated by the return sweep. As shown in FIGS. 2A, 2B, 2C and 2D, the arrangement is substantially the same as shown in FIGS. 1A, 1B and 1C except that the rotating polygon mirror has been replaced with a single oscillating flat mirror 34. As was the case with respect to FIG. 1A, FIG. 2A illustrates the beginning of a beam sweep at point 30 by the single axis mirror 34. Likewise, arrow 25 and dashed line 26 in FIG. 2B illustrate the direction of the beam sweep as mirror 34 substantially completes its scan. Referring to the lower view of the photosensitive drum 18, according to this prior art embodiment, the mirror 34 is mounted at a slight angle such that the beam sweep is synchronized with the movement of the rotating drum 18 so that the distance the medium moves is equal to the vertical distance the light beam moves during a sweep. As was the case for the polygon mirror of FIG. 1B, the slightly angled trajectory as illustrated by dashed line 26 results in a horizontal image line 28 on the moving photosensitive medium 16 or drum 18.

Thus, up to this point, it would appear that the flat surface single torsional axis oscillating mirror 34 should work at least as well as the rotating polygon mirror 30 as discussed with respect to FIGS. 1A, 1B, and 1C. However, when the oscillating mirror starts pivoting back in the opposite direction as shown by dashed line 26A in FIG. 2C, with prior art scanning mirror printers, it was necessary to turn the beam off and not print during the return sweep since the vertical movement of the mirror resulting from being mounted at a slight angle and the movement of the moving photosensitive medium 16 or rotating drum 18 were cumulative rather than subtractive. Consequently, if used for printing, the angled trajectory 26 of the return beam combined with movement of the rotating drum 18 would result in a printed image line 28A which is at even a greater angle than what would occur simply due to the movement of the rotating photosensitive drum 18. This, of course, is caused by the fact that as the beam sweep returns, it will be moving in a downward direction rather than an upward direction as indicated by arrow 36, whereas the photosensitive drum movement is in the upward direction indicated by arrow 38. Thus, as stated above, the movement of the drum and the beam trajectory are cumulative. Therefore, for satisfactory printing by a resonant scanning mirror printer according to the prior art, it was understood that the light beam and the printing were typically interrupted and/or stopped during the return trajectory of the scan. Thus, the oscillating mirror 34 was required to complete its reverse scan and then start its forward scan again as indicated at 30A, at which time the modulated laser was again turned on and a second image line printed.

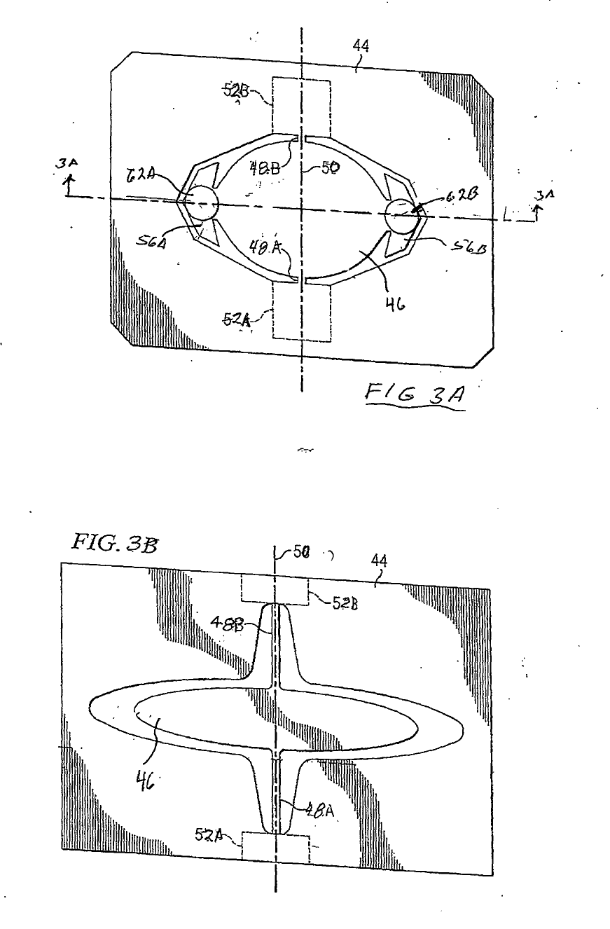

FIGS. 3A and 3B illustrate two embodiments of a single axis torsional mirror. The mirror of FIG. 3A includes a support member 44 supporting a substantially round mirror or reflective surface 46, and FIG. 3B illustrates a long elliptical mirror or reflective surface 46. Each of the mirrors are supported by a single pair of torsional hinges 48A and 48B. Thus, it will be appreciated that if the mirror portion 46 can be maintained in an oscillation state around axis 50 by a drive source, the mirror can be used to cause a sweeping light beam to repeatedly move across a photosensitive medium. It will also be appreciated that an alternate embodiment of a single axis mirror may not require the support member or frame 44 as shown in both FIGS. 3A and 3B. For example, as shown in FIG. 3A, the torsional hinges 48A and 48B may simply extend to a pair of hinge anchors 52A and 52B as shown in dotted lines on FIG. 3A. These type of hinge anchors could also be used with the elliptically shaped mirror of FIG. 3B. The reflective surface or mirror portion 46 is on the order of 110-400 microns in thickness, depending on the operating frequency, and is suitably polished on its upper surface to provide a specular or mirror surface.

Referring again to FIG. 3B, there is a top view illustration of the elliptical shaped single axis mirror apparatus particularly suitable for use to provide resonant oscillations for generating the repetitive beam sweep. An example of such a elliptical shaped mirror portion 46 found to be satisfactory has a long axis of about 4.0 millimeters and a short axis of about 1.5 millimeters. The functional parts of this embodiment are the same as that illustrated in FIG. 3A and, therefore, carry the same reference numbers. Further, because of the advantageous material properties of single crystalline silicon, MEMS based mirrors have a very sharp torsional resonance. The Q of the torsional resonance typically is in the range of 100 to over 1000. This sharp resonance results in a large mechanical amplification of the mirror's motion at a resonance frequency versus a non-resonant frequency. Therefore, according to one embodiment of this invention, it may be advantageous to pivot a mirror about the scanning axis at the resonant frequency. This dramatically reduces the power needed to maintain the mirror in oscillation.

There are many possible drive mechanisms to provide the oscillating beam sweep along the scan axis. The mirror mechanical motion in the scan axis is typically greater than 15 degrees and may be as great as 30 degrees. Since pivoting about the scan axis must move through a large angle and the mirror of FIG. 3B is long in that direction, both direct and resonant drive methods for producing movement about the scan axis have been found to be effective. Resonant drive methods involve applying a small rotational motion at or near the resonant frequency of the mirror directly to the torsionally hinged mirror or reflective surface, or alternately to the whole silicon structure which then excites the mirror to resonantly pivot or oscillate about its torsional axis. In inertial resonant type of drive methods a very small motion of the whole silicon structure can excite a very large rotational motion of the mirror. Suitable inertial resonant drive sources include piezoelectric drives and electrostatic drive circuits. A magnetic resonant drive that applies a resonant magnetic force directly to the torsional hinged reflective surface portion has been found to be especially suitable for generating the resonant oscillation for producing the back and forth beam sweep according to this invention.

Further, by carefully controlling the dimension of hinges 48A and 48B (i.e., width, length and thickness) the mirror may be manufactured to have a natural resonant frequency which is substantially the same as the desired oscillating frequency of the mirror. Thus, by providing a mirror with a resonant frequency substantially equal to the desired oscillating frequency, the power loading may be reduced.

Also, although an elliptical-shaped mirror has been found to be particularly suitable, it will be appreciated that the mirror could have other shapes such as for example, round, square, rectangular, or some other shape.

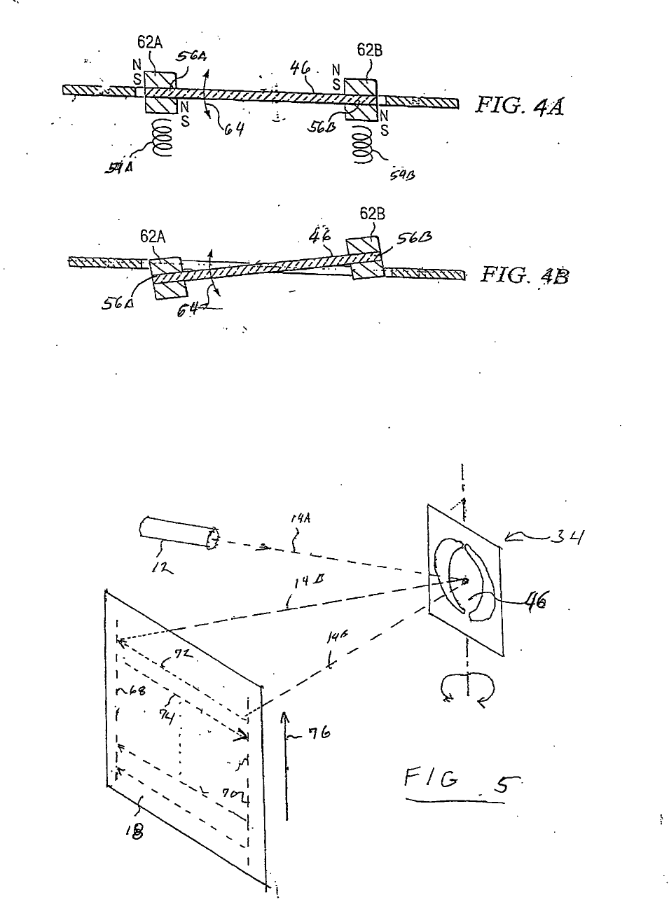

In addition to resonant drive sources, the mirror assembly may use a non-resonant electromagnetic drive source. Referring to FIGS. 4A and 4B along with FIG. 3A, mirror assembly 42 may include a pair of serially connected electrical coils 54A and 54B under tabs 56A and 56B respectively to provide the electromagnetic drive for the beam sweep. Thus by energizing the coils with alternating positive and negative voltage at a selected frequency, the mirror portion 46 can be made to oscillate at that frequency. To facilitate the electromagnetic drive, the mirror assembly may also include a pair of permanent magnets 62A and 62B mounted on tabs 56A and 56B of mirror portion 46 orthogonal to the axis 50. Permanent magnet sets 62A and 62B symmetrically distribute mass about the axis of rotation 50 to minimize oscillation under shock and vibration. Each permanent magnet 62A, 62B preferably comprises an upper magnet set mounted on the top surface of the mirror portion 46 using conventional attachment techniques such as adhesive or indium bonding and an aligned lower magnet similarly attached to the lower surface of the mirror portion 46 as shown in FIGS. 4A and 4B. The magnets of each set are arranged serially such as the north/south pole arrangement indicated in FIG. 4A. There are several possible arrangements of the four sets of magnets which may be used, such as all like poles up; or two sets of like poles up, two sets of like poles down; or three sets of like poles up, one set of like poles down, depending upon magnetic characteristics desired.

The middle or neutral position of mirror portion 46 of FIG. 3A is shown in FIG. 4A, which is a section taken through the assembly along line 3A-3A of FIG. 3A. Rotation of mirror portion 46 about axis 50 is shown in FIG. 4B as indicated by arrow 64.

FIG. 5 illustrates a perspective illustration of embodiment of the present invention using a single mirror which pivots about a single axis, such as the single axis mirror shown in FIGS. 3A and 3B. The reflecting surface 46 of the single axis mirror 34 receives the light beam 14A from source 12 and provides the right to left and left to right resonant beam sweep 14B between limits 68 and 70 as discussed with respect to FIGS. 2A, 2B, 2C and 2D. This left to right and right to left beam sweep provides the parallel lines 72 and 74 as the medium 18 moves in the direction indicated by arrow 76.

To this point there has been discussed various methods and arrangements for using resonant scanning mirrors as the drive engine for laser printers. The significant cost difference of polygon mirrors used for faster high speed printers is also understood to be a major problem for using high speed polygon mirrors as the engine to drive printers in the future. That is, the robust and advanced bearings necessary for the very high speed operation required by higher and higher printer speeds may limit their use except in the most expensive printer.

Therefore, it will be appreciated that although various types of non-resonant or resonant mirror can be used in the practice of this invention, the demand for higher and higher print speeds will require a higher and higher oscillation speed of the scanning mirror. However, in addition to high speed resonant oscillations of the mirror, it is also important that the scanning mirror not deform as it sweeps the laser beam across the photosensitive medium during a scan cycle. To this end, a multilayer resonant oscillating mirror driven by electromagnetic forces applied directly to the torsionally hinged mirror portion is believed to be particularly suitable for this invention. The preferred multilayered mirror has a first single crystal silicon layer for the torsional hinges, a second layer for the reflecting surface and a third layer for providing stiffness to the reflective surface to prevent distortion.

As will be appreciated by those skilled in the printer art, basic office printers continue to improve. For example, in the recent past, an addressable pixel resolution of about 300 dots or pixels per inch was considered as being acceptable for many printers. However, the printer technology has steadily improved such that about 1200 addressable dots or pixels per inch is now the industry standard and 2400 dots per inch is fast becoming the industry standard.

This increase in dots or pixels per inch has of course required faster and faster beam sweeps. For the polygon mirror printers, this increase means that the mirror must spin at greater and greater speeds, which in turn requires more advanced bearing technology to support continuous high speed spin rates. Consequently, the cost and complexity of polygon mirror drives also continues to increase. It has been discovered, however, that the requirement of higher and higher beam sweep rates provide greater opportunities for the use of resonant scanning mirrors in high quality printing. For example, the cost of manufacturing a resonant scanning mirror having a resonant frequency of around 1500 Hz or around 3000 Hz is not significantly different. However, of even greater importance, at faster print rates (i.e., dots or lines per inch) the laser spots start overlapping or eclipsing themselves. This means that the non-parallel lines or zig-zag pattern of the printer lines produced by bi-directional printing with a single axis resonant mirror becomes immaterial.

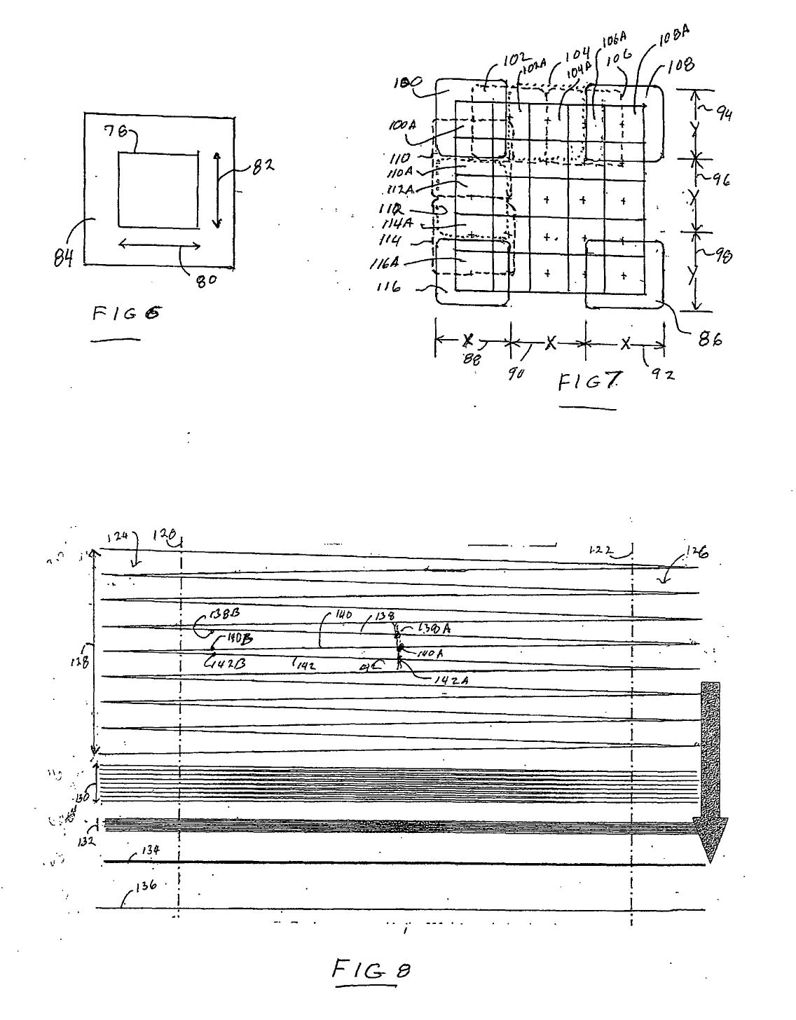

Referring now to FIG. 6 there is shown, for example only, an illustration of a single addressable pixel 78, which when combined with other pixels makes up an image. The figure also illustrates a comparison of the addressable pixel size with the resulting beam or laser spot size on the printer photosensitive medium when the addressable pixel is turned “ON.” The width of addressable pixel 78 as indicated by the double headed arrow 80 and the height of the pixel 78 as indicated by double headed arrow 82 also illustrates the horizontal and vertical separation respectively between the centroids of horizontally adjacent pixels and vertically adjacent pixels. The large area 84 represents the spot size of the laser beam on the photosensitive medium. It should be understood at this point that the laser spot will actually be a circle or oval shape rather than the rectangular or square shape indicated by area 84. However, use of the square area 84 to represent a laser beam spot simplifies the explanation. The laser or beam spot made on the photosensitive medium or paper for one addressable pixel is typically about three to four times the addressable pixel. In the example of FIG. 6, it is assumed to be about four times that of the addressable pixel and will actually have a round or elliptical shape rather than the substantially rectangular shape indicated by reference number 84 in FIG. 6, or by reference number 86 in FIG. 7, which illustrates the pattern of laser spot images in the center portion of a page using a bi-directional single axis scanning mirror.

More specifically as shown in FIG. 7, the horizontal dimension X of the beam spot is shown to be about two times the horizontal dimension of the addressable pixels, and the vertical dimension Y of the beam spot is also about two times the vertical dimension of the addressable pixels.

It is assumed that the addressable pixel size across the page (horizontal) for FIG. 7 is about 1200 dots per inch which, as mentioned above, is about the commercial standard today. The commercial standard is rapidly moving to 2400 dots per inch. Similarly, the vertical addressable pixel size is also assumed to be about 1200 dots or lines per inch in FIG. 7. Therefore, an area equivalent to nine laser beam spots (three across, as indicated by double headed arrows 88, 90 and 92, and three vertical, as indicated by double headed arrows 94, 96 and 98) is illustrated. However, as is also shown, the three laser spots or 3X horizontal dimension is printed with five laser spots 100, 102, 104, 106 and 108 by turning on the five horizontal addressable pixels 100a, 102a, 104a, 106a and 108a in a row. Similarly, the three laser spots or 3Y vertical dimension is printed with five laser spots 100, 110, 112, 114 and 116 by turning on the five vertical addressable pixels 100a, 110a, 112a. 114a and 116a. It will be noted, that the actual area printed by the laser spots is greater than the addressable pixel area. However, at 1200 pixels per inch the horizontal separation between addressable pixel centroids is 0.000833 inches. So, even if both the horizontal and vertical dimensions of the laser spots are double that of the addressable pixel, the print over run will be no greater than about 0.000415 inches in each direction.

Therefore, according to the present invention, a single axis resonant scanning mirror may be used to provide bi-directional high quality printing. A further illustration of how higher and higher print rates reduces the artifact of zig-zag print lines is provided in FIG. 8.

Referring to FIG. 8, there are shown samples of the laser beam path on a photosensitive target at various dots per inch print rates. It should be noted that the examples are not to scale. The lines 120 and 122 represent the left and right print limits. The areas 124 and 126 to the left and right of the limit lines 120 and 122 show the beam path as the laser beam reverses direction. Each of the five examples 128, 130, 132, 134 and 136 of different print rates represent eight complete scan cycles when a cycle is defined as one scan in each direction. For example, in the example 128, which represents 2.7 vertical dots per inch, the zig-zag beam path is obvious and clearly cannot be used to produce images for printing. Likewise, the example 130 represents about 16 vertical dots per inch and, although clearly superior, the zig-zag of the lines can be seen and consequently will not print an acceptable image. The example 132 represents about 40 lines per inch and, although the shape of the zig-zag line is not easily detectable without magnification, very notable artifacts will be present on an image or printed page.

In the example of 134 representing about 100 lines per inch, the laser spots are beginning to merge or slightly overlap. Printing at this rate of dots or pixels per inch is suitable for some types of printing, but still leaves some notable artifacts and cannot be used for high quality printers.

Finally, the example 136 represents about 600 dots or lines per inch and is believed to approximate the threshold at which the zig-zag in the scan line becomes immaterial. The spacing between addressable pixels or lines at 600 dots per inch is about 0.001666 inches and, because the laser spot may have a vertical dimension almost twice that of the addressable pixel, there is significant overlap. Furthermore, the 0.001666 inches separation or zig-zag of the print lines take place over 8½ inches on a typical page and simply become immaterial. In addition, as has been mentioned, most printers now print at a rate of 1200 dots or pixels per inch (industry standard), which is a separation of only 0.0008333 inches. Of course, when the industry standard is 2400 dots per inch the separation will be 0.000415.

Although, as was discussed, the line shape or zig-zag between adjacent lines becomes insignificant at higher and higher print rates. For the high quality printing, the zig-zag pattern should be balanced substantially between the forward and the return sweep so that both lines have the same angle to the center line of the print window.

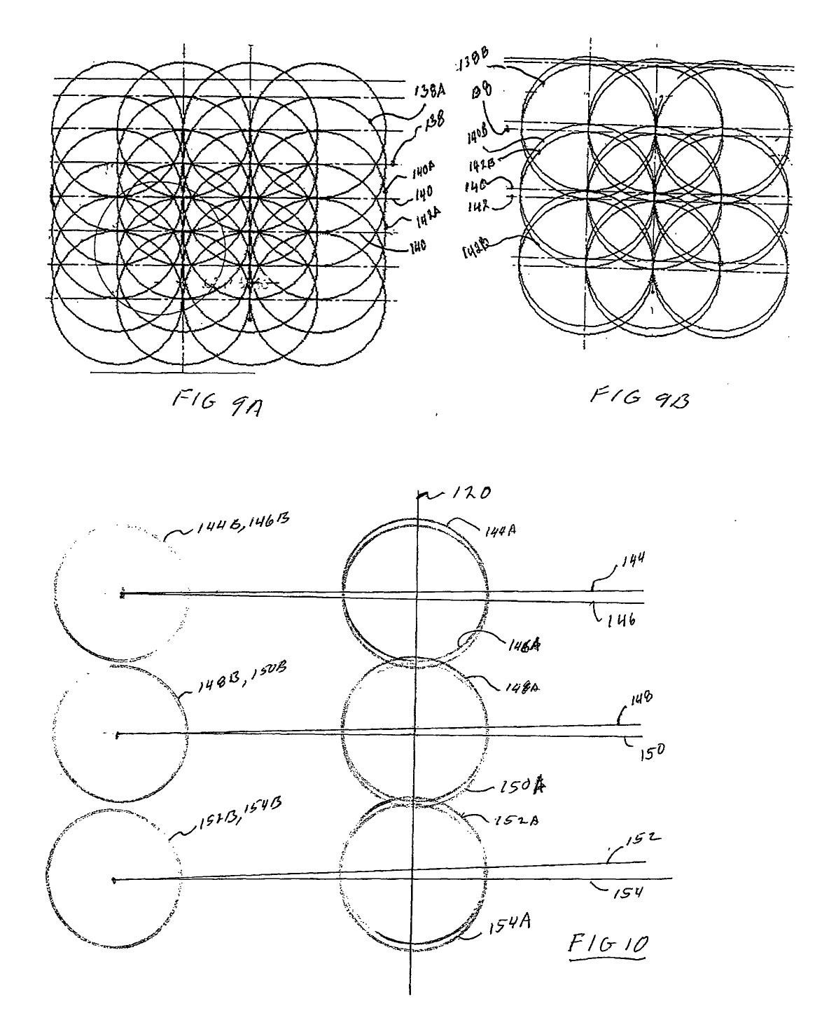

As was discussed, FIG. 7 illustrates the image spots or “footprints” of the laser beam on the photosensitive medium at the center of a balance zig-zag scan when corresponding addressable pixels are turned “ON.” However, such a consistent and equal vertical overlap as shown is only present at the center of the horizontal scan. The vertical overlap of an image line increases with one of its adjacent lines and becomes less and less with the other as the scan beam moves further away from the center. For example, referring again to FIG. 8, it is seen that at the center point 140a of scan line 140 is equal distance from the previous scan line 148 and the next scan line 142 as indicated by center points 138a and 142a respectively. However, the scan line 148 is separated by significantly greater distance from the previous scan line 138 as it approaches the limit line 120 and as illustrated by points 140b and 138b. On the other hand, scan line 140 moves substantially closer to scan line 142 as it approaches limit line 120 as illustrated by points 140b and 142b. A comparison of the vertical overlap of image spots at the center and end points of a scan line due to the zig-zag motion of the scan is better illustrated by referring to FIGS. 9A, 9B and 10, as discussed with respect to the left-hand end of the cycle. However, it will be appreciated the discussion is also applicable to the right-hand end of the scan cycle, although the line carrying is different.

FIG. 9A is somewhat similar to that discussed with respect to FIG. 7, except the laser “footprint” or image spot is illustrated as a round area and the image lines are closer together. Furthermore, the scan lines 138, 140 and 142 were discussed with respect to the eight scan cycles of display 128 representing 2.7 lines per inch for convenience. For ease of explanation, FIGS. 9A and 9B also use scan lines 138, 140 and 142. However, the laser spot size or “footprint” and overlap is more representative of the eight scan lines of display representing 600 or more lines or dots per inch of display area as they would appear when greatly enlarged.

Thus, as shown in FIG. 9A, all of the scan lines including scan lines 138, 140 and 142 are equally spaced. Further, the spot image or “footprint” as can be seen by spot 140a or image line 140 will overlap portions of six other laser spots in a vertical direction (three previous image lines and three subsequent image lines).

However, FIG. 9B illustrates the laser spots overlap or image lines 138, 140 and 142 in the area 124 at the left-hand end of the beam scan. As can be seen, the laser spots tend to pair up in the vertical direction. Thus, a laser image spot 140b on image line 140 is almost on top of image spot 142b which moves along image line 142, but the separation from image line 138 is substantially increased such that the overlap between laser spots 140b and 138b is reduced. However, the overlap is still about 50% in this illustration and there is no separation visible to the naked eye and, therefore, the zig-zag is substantially immaterial.

Therefore, it will be appreciated that so long as there is some overlap of the image spot, adjacent image lines at the print limit lines 120 and 122, the zig-zag of the image lines will not be visible. Thus, FIG. 10 illustrates a very limited overlap at the left-hand end limit line 120 with respect to image spot pairs 144a-146a, 148a-150a, and 152a-154a such that the zig-zag of the image lines is not visible. With a very limited overlap as shown in FIG. 10, it will be appreciated that the very end of the scan (left and right) the laser spot of a scan line will actually be on top of each other such as laser spots 144b and 146b. However, the scan pair has no overlap at all with its closest scan pair 148b and 150b. However, so long as there is overlap at the limit lines 120 and 122 (122 not shown in FIG. 10), the zig-zag of the beam zig-zag line should not be visible.

Using a constant scanning speed of a resonant mirror provides other advantages in addition to reducing the inventory of different mirrors. For example, a common mirror drive and a common optical cavity may be used for all printer speeds. In addition, the photo chemistry is the same for all printers and does not have to be adjusted for different printer speed points.

The foregoing descriptions of specific embodiments of the present invention have been presented for purposes of illustration and description. They are not intended to be exhaustive or to limit the invention to the precise forms disclosed as many modifications and variations are possible in light of the above teaching. The embodiments were chosen and described in order to best explain the principles of the invention and its practical application to thereby enable others skilled in the art to best utilize the invention and various embodiments with various modifications as are suited to the particular use contemplated. It is intended that the scope of the invention be defined by the claims appended hereto and their equivalents.

What is claimed is:

1. In a printer using a single scanning mirror, a method of doubling the printing speed comprising the steps of:
providing a light beam;
providing a moving photosensitive medium sensitive to said light beam;
intercepting said light beam at the reflecting surface of a scanning mirror and redirecting said light beam toward said moving photosensitive medium;
oscillating said scanning mirror to sweep said light beam back and forth across said moving photosensitive medium;
generating digital signals for modulating said bi-directional light beam as said light beam sweeps across said moving photosensitive medium to control addressable pixels comprising an image line of a selected image; and
moving said photosensitive medium substantially orthogonal to said oscillating modulated light beam such that successive bi-directional image lines combine to form said selected image.

2. The method of claim 1 further comprising positioning said scanning mirror such that said back and forth motion of said light beam across said moving photosensitive medium tracks along a substantially balanced zig-zag path.

3. The method of claim 1 wherein said step of generating digital signals and said step of moving said photosensitive medium are coordinated to generate said addressable pixels at a selected vertical pixel rate.

4. The method of claim 3 wherein said selected vertical addressable pixel rate on said medium is at least 600 pixels per inch.

5. The method of claim 4 wherein said size of at least 600 pixels per inch is at least 1200 pixels per inch.

6. The method of claim 5 wherein said size of at least 1200 pixels per inch is at least 2400 pixels per inch.

7. The method of claim 3 wherein said step of modulating said light beam to control said addressable pixels comprising an image line occurs within left and right limits on said photosensitive medium and wherein the speed for moving said photosensitive medium orthogonal to said beam sweep and the spot size of said laser beam are selected such that laser spots of adjacent image lines located between said left and right limits overlap.

8. The method of claim 1 further comprising the step of selecting said light beam to have a spot area of at least three times said addressable pixel area such that adjacent “ON” pixels create overlapping beam spots on said moving photosensitive medium.

9. The method of claim 1 wherein the step of oscillating said scanning mirror comprises the step of oscillating said scanning mirror at a resonant frequency of said mirror.

10. The method of claim 1 wherein said step of intercepting said light beam at the reflecting surface of a scanning mirror comprises the step of intercepting said light beam with a scanning mirror having torsional hinges made of single crystal silicon.

11. The method of claim 10 wherein said scanning mirror is a multilayered mirror driven at a resonant frequency by a magnetic source.

12. A high quality printer comprising:
a laser light beam for creating a spot area on a photosensitive medium;
a moving photosensitive medium sensitive to said light beam;
a scanning mirror for interrupting said light beam and redirecting said light beam toward said moving photosensitive medium;
a mirror drive for oscillating said scanning mirror to sweep said light beam back and forth across said moving photosensitive medium;
circuitry for generating digital signals for modulating said light beam as said light beam sweeps across said photosensitive medium to control addressable pixels comprising image lines representing a selected image, said digital signals being generated at a selected rate;
circuitry for receiving said generated digital signals and for modulating said sweeping light beam in both directions; and
a drive source for continuously moving said photosensitive medium substantially orthogonal to said sweeping light beam to produce image lines at a said selected rate.

13. The printer of claim 12 wherein said moving photosensitive medium is a rotating drum.

14. The printer of claim 12 wherein said scanning mirror is supported by a pair of torsional hinges.

15. The printer of claim 14 wherein said pair of torsional hinges are formed from a single crystal silicon.

16. The printer of claim 15 wherein said scanning mirror is a multilayered scanning mirror.

17. The printer of claim 12 wherein said scanning mirror oscillates at the mirrors resonant frequency.

18. The printer of claim 17 wherein said resonant frequency is between about 3000 and 4000 Hz.

19. The printer of claim 12 wherein said image lines are a balanced zig-zag with respect to a horizontal line across said photosensitive medium.

20. The printer of claim 12 wherein said drive source is a magnetic drive source.

21. The printer of claim 12 wherein said rate of generating said digital signals is selected to control at least 600 addressable pixels per inch.

22. The printer of claim 21 wherein said laser spot size on said photosensitive medium has an area of at least three times the area of an addressable pixel.

23. The printer of claim 12 wherein said image lines extend between a left and right limit, and the laser spots on consecutive image lines overlap.

24. A printer drive engine for intercepting a light beam and redirecting the light beam toward a moving photosensitive medium comprising:
a scanning mirror having a reflecting surface for interrupting said light beam and redirecting said light beam toward said moving photosensitive medium;
a mirror drive for oscillating said scanning mirror to sweep said light beam back and forth across said moving photosensitive medium;
circuitry for generating digital signals for modulating said light beam as said light beam sweeps across said photosensitive medium to control addressable pixels comprising image lines representing a selected image, said digital signals being generated at a selected rate; and
circuitry for receiving said generated digital signals and for modulating said sweeping light beam in both directions to produce an image on said moving photosensitive medium, said image lines of said image overlapping.

25. The drive engine of claim 24 wherein said scanning mirror is supported by a pair of torsional hinges.

26. The drive engine of claim 25 wherein said pair of torsional hinges are formed from a single crystal silicon.

27. The drive engine of claim 26 wherein said scanning mirror is a multilayered scanning mirror.

28. The drive engine of claim 24 wherein said scanning mirror oscillates at the mirrors resonant frequency.

29. The drive engine of claim 24 wherein said resonant frequency is between about 3000 and 4000 Hz.

30. The drive engine of claim 24 wherein said rate of generating said digital signals is selected to control at least 600 addressable pixels per inch.
